(19) United States
(12) Patent Application Publication
(10) Pub. No.: US 2003/0230828 A1
(43) Pub. Date: Dec. 18, 2003

(54) Method of manufacturing a multi-port nozzle for dispensing liquids and nozzles produced therefrom

(76) Inventors: Christopher Young, West Greenwich, RI (US); Paul R. Nannig, North Kingstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/420,085

(22) Filed: Apr. 22, 2003

Related U.S. Application Data
(60) Provisional application No. 60/389,167, filed on Jun. 17, 2002.

(51) Int. Cl. B29B 13/00

(52) U.S. Cl. 264/271.1

(57) ABSTRACT

A method of making a multi-port nozzle having multiple tubular ports for dispensing liquids is provided. The method involves introducing a molten polymer composition into a connector device mounted on a die plate. The connector device has a plurality of plastic tubes projecting therefrom. The molten composition surrounds and bonds to the tubes. Subsequently, the connector device having tubes attached thereto can be removed from the die plate. The resulting connector nozzle can be used to discharge liquids in various applications such as industrial coating operations.

### CROSS-REFERENCE TO RELATED APPLICATIONS

This application claims the benefit of U.S. Provisional Application 60/389,167 having a filing date of Jun. 17, 2002.

### BACKGROUND OF THE INVENTION

The present invention relates to a method for making a nozzle having multiple plastic tubular ports for dispensing liquids. The invention also includes the nozzles made from such methods.

Nozzles having a single tubular port for dispensing liquids are used in various industrial applications. For example, a manufacturer's emblem or label is often affixed to electrical appliances, sporting equipment, and other consumer or industrial products. The emblem may bear the name, trademark, and/or logo of the manufacturer. A polyurethane, epoxy, and/or silicone coating is often applied to the surface of the emblem prior to adhering the emblem to the product. The clear coating provides a protective finish to the emblem.

In such an emblem-coating operation, a set of uncoated emblems is first arranged on a supporting tray. A nozzle having a singular tubular port attached thereto is used to apply the polyurethane, epoxy, and/or silicone coating to each emblem individually. The tubular port is placed over a single emblem and the coating is fed through the tube and onto the surface of the emblem. The single tubular port is then moved to a position over the next emblem and the polyurethane coating is discharged onto the surface of that emblem. The emblems are coated on a one-by-one basis using this method. This coating process can be used for small manufacturing jobs, but it is time-consuming and not economically feasible for large jobs.

It is known that single tubular ports can be used in other liquid-dispensing applications.

For example, Westlake, U.S. Pat. No. 3,270,114 discloses a method of molding a single tube to a flanged member of a cap or bag in order to provide a seal between the tube and the flanged member. In the method described in the '114 Patent, hot polyethylene is injected into a mold cavity located between two molding members. The molten polyethylene fuses to the end of the tube to form a homogenous structure between the tube and cap or bag. The molding members are then removed to produce the end product, a cap or bag having a single fused tube. The fused tube can be used for dispensing fluids, such as milk, from the bag according to the '114 Patent.

Steer et al., U.S. Pat. No. 5,002,623 discloses a method of manufacturing a bag for containing a liquid. The bag has a single outlet tube for dispensing the liquid. The manufacturing method involves seam welding an outlet tube between two superposed bag walls. The tube/bag combination is then placed between the blocks of a mold. A molten plastic material, for example polyethylene, is injected into the mold. The injected plastic forms a collar that completely surrounds the tube. The collar is molded around and integrated with the material of the tube and the adjacent portions of the bag material to produce a bag having a single outlet tube.

In view of the foregoing problems with using single tubular ports in large manufacturing operations, it would be desirable to have a nozzle with multiple tubular ports for dispensing a liquid efficiently. There is a demand for such a multi-port nozzle, because it could be used to coat the surfaces of multiple emblems or other substrate materials simultaneously and uniformly in a controlled manner. The multi-port nozzle could be used for other liquid-dispensing applications as well. The present invention provides a method for making such a multi-port nozzle. The present invention also includes the multi-port nozzles made from such methods.

There are some conventional multi-port nozzle assemblies consisting of multiple brass tubular ports attached to a nozzle device. Each tubular port is soldered independently to the nozzle. This method for making multi-port nozzles is burdensome especially when the nozzle contains many tubular ports and there is a complex geometric lay-out of the ports. For example, it may be necessary to have precise spacing between each tubular port. It can be time-consuming and costly using this soldering method to make such nozzles. Further, these brass multi-port nozzles are generally not considered to be disposable, throw-away items. Thus, the nozzles must be cleaned with chemical solvents or other materials after each use, and this cleaning process adds another costly step to the overall liquid-dispensing operation.

In view of the aforementioned problems with conventional methods for making nozzles having multiple tubular ports, it would be desirable to have a new and efficient method for making multi-port nozzles. The nozzle should be capable of delivering a liquid through the multiple tubular ports efficiently. Further, the tubular ports should be durable and flexible so that they can deliver the liquid to various locations precisely and uniformly. In addition, the connector nozzle should be made from inexpensive and disposable materials so that it can be disposed of easily. The present invention provides such a method. The present invention also encompasses new and unique multi-port nozzles made from such a method.

### SUMMARY OF THE INVENTION

The present invention relates to a method for making a multi-port nozzle. The nozzle has multiple tubular ports for dispensing liquids and can be used in various end-use applications. In one embodiment, the method comprises the steps of: a) providing a mold assembly, said assembly including a die plate having a plurality of post elements projecting therefrom and a removable connector device attached to the die plate, wherein said connector device surrounds the post elements; b) inserting a plurality of plastic tubes onto the post elements; c) introducing a molten polymer composition into the connector device of the mold assembly so that the composition surrounds and bonds to the tubes; and d) removing the connector device from the mold assembly to form a connector nozzle having multiple tubular ports extending therefrom.

The connector device can have a threaded end so that it can be fastened securely to the die plate. The threaded connector can be screwed into a recessed area of the die plate. Typically, the connector device has a cylindrical structure, and the multiple post elements and elongated plastic tubes have round cross-sections. The post elements and plastic tubes can have substantially the same diameters.

The polymer composition can comprise a polymer selected from the group consisting of polyvinyl chloride, polyamides, fluorocarbons, polyethylene, polyurethane, polystyrene, cellulosics, acrylics, epoxies, elastomers, polyesters, polyimides, and acrylonitriles, and mixtures thereof. The elongated plastic tubes attached to the post elements can be made from any suitable material such as fluorocarbon resins, polyamides (nylon), polyimides, and silicones can be used. In one embodiment, the polymer composition comprises polyurethane and the plastic tubes comprise nylon. Particularly, nylon 11 can be used to make the plastic tubes. The present invention also encompasses the connector nozzles made in accordance with the above-described methods.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description taken in connection with the accompanying drawings in which:

FIG. 1 is a top view of a die plate that can be used to make a multi-port nozzle in accordance with the present invention;

FIG. 2 is a side perspective view of a connector device that can be used to make a multi-port nozzle in accordance with the present invention;

FIG. 3 is a side perspective view of a plastic tube that can be used to make a multi-port nozzle in accordance with the present invention;

FIG. 4 is a perspective view of a standing ring apparatus that can be used to support the plastic tubes in FIG. 3 in accordance with the present invention;

FIG. 5 is a side perspective view of a multi-port nozzle made in accordance with the present invention;

FIG. 6 is a top view of a series of die plates that can be used to make various multi-port nozzles in accordance with the present invention;

FIG. 7 is a schematic view of the multi-port nozzle of the present invention being used to dispense a liquid coating onto multiple emblem substrates; and

FIG. 8 is an enlarged view of the multi-port nozzle and emblem substrates of FIG. 7.

### DETAILED DESCRIPTION OF THE PREFERRED EMBODIMENTS

This invention relates to a method for making a nozzle having multiple projecting tubular ports. The ports can be employed for dispensing liquids in various end-use applications. The invention also includes the nozzles made from such methods.

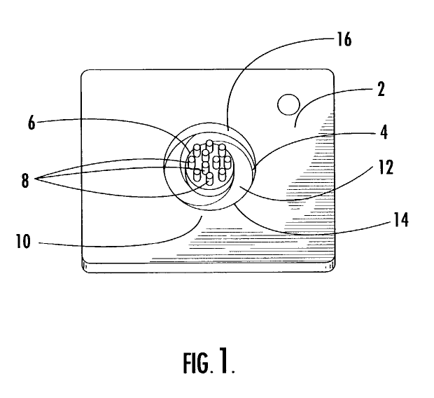

Referring to FIG. 1, a die plate 2 having a recessed portion 4 in the center of the plate 2 is shown. The recessed portion 4 contains a die member 6 having a plurality of post elements 8 projecting therefrom. The post elements 8 can be in the form of relatively small pins, rods, bosses, or other projecting structures. The recessed portion 4 is shown having a cylindrical shape. The diameter of the recessed portion 4 is larger than the diameter of the die member 6 so that the recessed portion 4 can easily house the die member 6. The recessed portion 4 completely surrounds the die member 6 to form an annular gap 12 between the edge 14 of the recessed portion 4 and the die member 6.

The recessed portion 4 is of sufficient depth so that it may hold a connector device 18 (not shown) in place. The inside surface 16 of the recessed portion 4 may be threaded so that a connector device 18 can be screwed thereon as discussed further below. In FIG. 1, the recessed portion 4 and die member 6 are shown having cylindrical shapes for illustration purposes only. It is understood that the recessed portion 4 and die member 6 can have any suitable shape or structure. For example, the recessed portion 4 and die member 6 can be square-shaped.

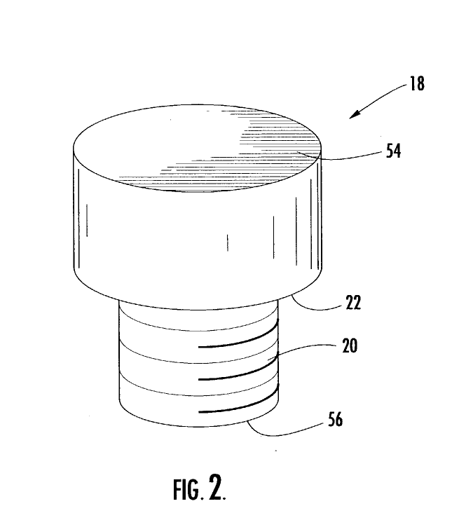

The connector device 18 is fastened to the die plate 2. As shown in FIG. 2, the connector 18 is a hollow fastener having open top 54 and lower 56 portions. The connector 18 can have a threaded portion 20 so that it can be screwed into the threaded, recessed portion 4 of the die plate 2. The connector 18 has a flanged portion 22 so that when it is threaded into the recessed portion 4, it creates an effective seal with the surface 10 of the die plate 2. The connector device 18 can be made from a plastic or any other suitable material.

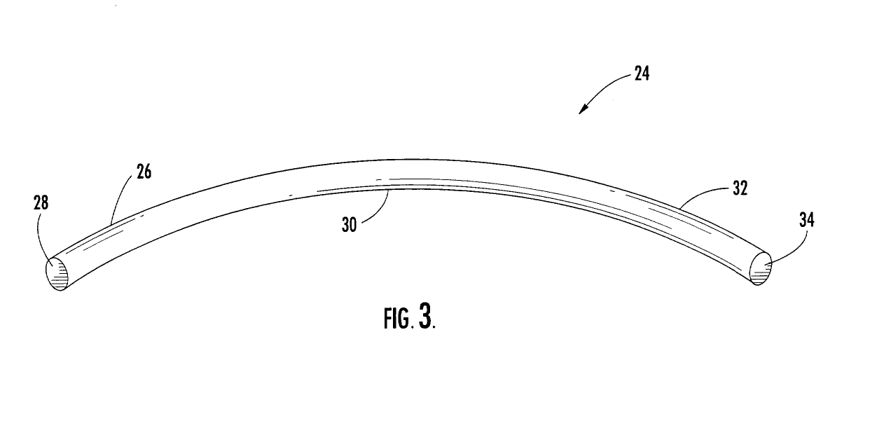

Referring to FIG. 3, elongated tubes 24 are used to make the multi-port nozzles of this invention. In FIG. 3, the tubes 24 are shown having a cylindrical structure with a round cross-section. However, it is understood that the tubes 24 can have other shapes depending upon the intended application. The tubes 24 are made from a plastic material. For example, plastics having good resistance to high temperatures such as fluorocarbon resins, polyamides (nylon), polyimides, and silicones can be used. Particularly, nylon 11 can be used to make the plastic tubes. Other plastic materials such as polyvinyl chloride, polyethylene, polypropylene, polyurethane, polystyrene, cellulosics, epoxies, elastomers, and acrylic resins can also be used to make the tubes 24.

The plastic tubes 24 are durable, flexible, and capable of delivering liquids in accordance with this invention. The diameter and thickness of the tubes will vary depending on the intended end-use application and properties of the liquid being dispensed (pressure, temperature, and the like). For example, the plastic tubes can be made from nylon 11 and have an outside diameter of 0.125 inches and an inside diameter of 0.093 inches with a wall thickness of 0.016 inches. The tubes have a first end portion 26 with an opening 28 (or inlet port) for receiving a liquid, an elongated body portion 30, and a second end portion 32 with an opening 34 (or outlet port) for dispensing the liquid. The opening 28 of the tube 24 is inserted onto a post element 8 on the die plate 2. The tube 24 and post element 8 each have substantially the same diameter so that the tube 24 can be inserted snugly onto the post element 8. In the present invention, a plurality of tubes 24 are inserted onto the post elements 8 so that the mounted connector device 18 and die plate 2 (mold assembly) holds the tubes 24 in position, and a substantial portion of each tube 24 protrudes from the mold assembly.

It is recognized that there are different ways to fabricate the mold assembly. For instance, in one embodiment, the connector device 18 is first secured to the die plate 2 , and then the plastic tubes 24 are mounted on the post elements 8. The molten polymer composition is then poured into the open top portion 54 of connector device 18. In other embodiments, the plastic tubes 24 can be first mounted on the post elements 8, and then the connector device 18 can be slipped over the tubes 24 and fastened to the die plate 2. The molten polymer composition can be then fed into the open portion 54 of the connector device 18.

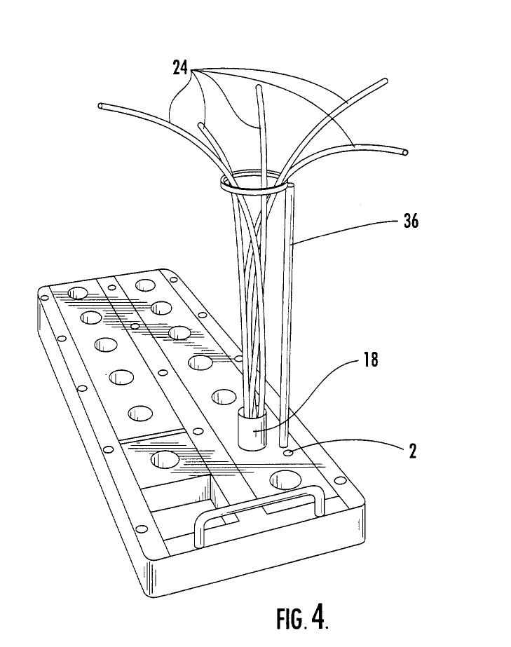

A standing ring apparatus 36 can be used to help in the mounting and positioning of the plastic tubes 24 on the post elements 8. The standing ring 36 keeps the tubes 24 standing upright during the molding process as illustrated in FIG. 4.

A variety of molten polymer compositions can be introduced into the connector device 18 mounted on the die plate 2 (mold assembly); provided that the composition is capable of surrounding and bonding to the projecting tubes 24. The polymer composition can comprise a thermoplastic polymer such as polyvinyl chloride, polyamides, fluorocarbons, polyethylene, polyurethane, polystyrene, cellulosics and acrylic resins. Thermosetting polymers such as epoxies, elastomers, polyesters, polyimides, and acrylonitriles can also be used. The polymer composition can further contain additives such as viscosity modifiers, stabilizers, fillers, pigments, and the like.

The molten polymer composition can be introduced into the mold assembly using a casting/potting process or other suitable method. Pellets of the polymer composition may be heated so that a molten composition (liquid plastic) forms. The molten composition can be poured into the mounted connector device 18 so that it substantially fills the device 18. The melt temperature of the molten polymer should be less than the melt temperature of the material used to make the plastic tubes 24. It is important for the molten composition to have good flow and leveling properties so that it can flow and uniformly surround each projecting plastic tube 24 mounted on a post element 8. Further, the molten composition needs to have good bonding properties so that it can mechanically bond to each tube 24.

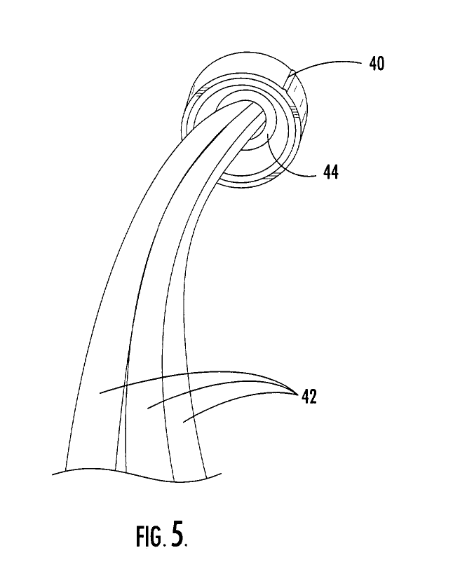

After the molten polymer has cooled, the connector device 18 containing the solidified polymer and bonded tubes 24 is removed from the die plate 2. The resulting connector nozzle 40 has multiple tubular ports 42 extending therefrom as shown in FIG. 5. The tubular ports 42 remain firmly secured in the connector nozzle 40 by means of the solidified polymer 44 that fills the connector 40 and mechanically bonds to the tubular ports 42. The nozzle 40 can be connected to various liquid-containing vessels, and the liquid can be discharged through the tubular ports 42.

The molten material that bonds to the plastic tubes 24 and the tubes 24, themselves, can be of the same or different polymer compositions. In one embodiment, the tubes 24 are made from a polyamide, and the molten polymer composition is polyurethane. In either event, the composition of the molten polymer and tubes 24 should be compatible so that the molten polymer can effectively surround and mechanically bond to the tubes 24 . The tubes 24 may be coated with a primer to improve adhesion between the tubes 24 and polymer composition.

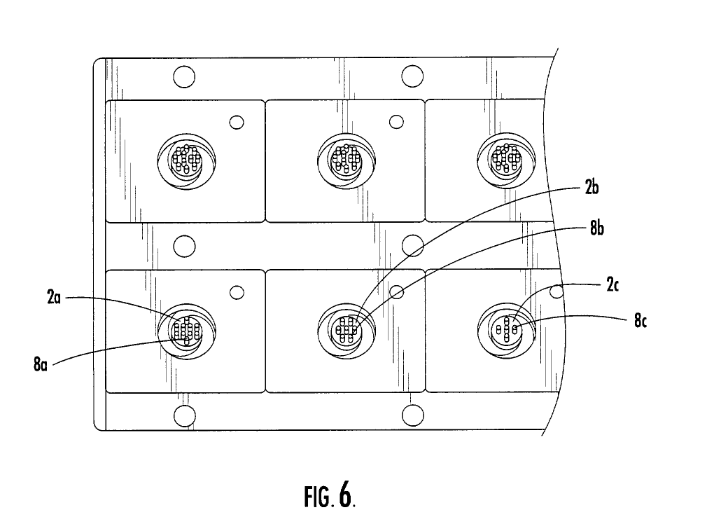

The method of this invention can be used to make a variety of multi-port nozzles each having a different tubular port design. These different multi-port nozzles are made using die plates 2 having different amounts and configurations of post elements 8 as shown in FIG. 6. For example, die plate 2a has ten projecting post elements 8a arranged in four rows. Die plate 2b has seven post elements 8b arranged in three rows, and die plate 2c has five post elements 8c arranged in a diamond-like shape.

The multi-port nozzle of this invention can be used to dispense liquids for various end-use applications. As discussed above, a manufacturer's emblem or label is often attached to electrical appliances, sporting equipment, and other consumer or industrial products. It is common to apply a protective coating, such as a polyurethane finish, to the surface of the emblem. This clear coating is durable and helps protect the emblem from soiling, fading, and other environmental effects. The polyurethane coating further provides the emblem with an aesthetically pleasing finish.

The multi-port nozzle of this invention can be used in such emblem coating operations. Particularly, these coating operations may use a two (2) package liquid dispensing system. Each self-contained package or box may contain a chemical component used to prepare a liquid mixture. For example, a two-part liquid polyurethane mixture can be prepared from package “A” containing a prepolymer having isocyanate groups and package “B” containing a polyol. The packages A and B can be warmed by placing them on a heating tray. The components from each box are measured and fed to a static mixer, where they are mixed to form a liquid polyurethane mixture. There is no need to de-gas the liquid mixture, since the chemical components of the mixture are boxed separately and metered to the static mixer.

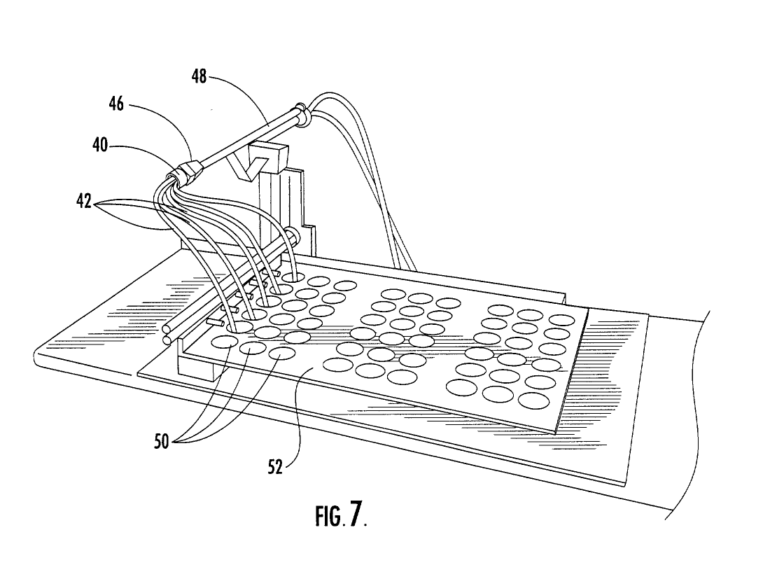

As shown in FIG. 7, the multi-port nozzle 40 is attached to the output end 46 of the static mixer 48. The input port (not shown) of the multi-port nozzle 40 can be threaded onto the static mixer 48. The liquid polyurethane is fed through the connector nozzle 40 and into the multiple plastic tubular ports 42. A computerized pump can be used to control the application speed, volume, temperature, and other properties of the liquid.

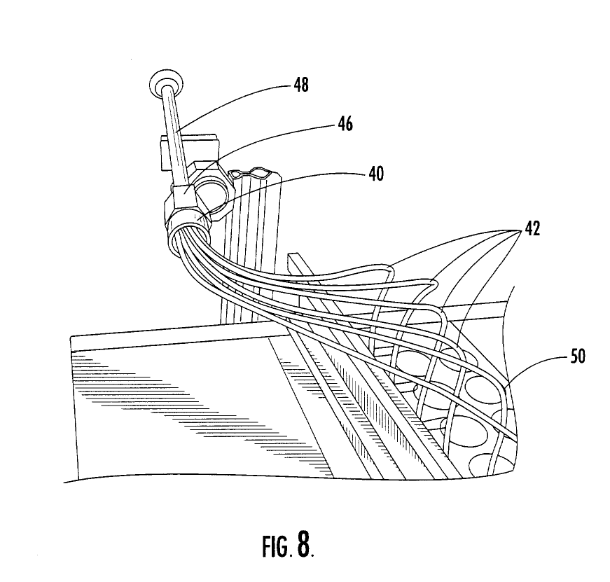

The emblems 50 are arranged in rows on a supporting tray 52 in FIG. 7. The multiple tubular ports 42 dispense the liquid polyurethane in a controlled manner to the surfaces of multiple emblems. Thus, a uniform coating is applied simultaneously to the different emblems 50. As shown in FIG. 8, the multi-port nozzle 40 and flexible nature of the plastic tubes 42 allows an operator to precisely position the outlet end 34 of a tube 42 so that the liquid polyurethane is applied to a specific location on a given emblem 50. The coatings may be dried and cured by placing the coated emblems in a drying oven. Such liquid dispensing systems are available from Development Associates, Inc. (North Kingstown, R.I. 02852) under the mark, MICRO MAX casting machines.

In FIGS. 7 and 8, the substrate material for receiving the coating is shown as a set of emblems 50 for illustration purposes only. It is understood that other materials can be coated using the multi-port nozzle 40 of the present invention. The multi-port nozzle has many advantageous features and can be used in a variety of liquid-dispensing applications. The multi-port nozzle delivers liquid through the tubular ports in a regulated and uniform manner. The tubular ports are durable and flexible so that they can deliver the liquid precisely to different locations on a substrate or elsewhere as needed. The multi-port nozzle is made from inexpensive and throw-away materials so that it can be disposed of easily. Thus, the connector nozzle can be used for a single coating application and then disposed thereof.

It is appreciated by those skilled in the art that various changes and modifications can be made to the illustrated embodiments and description herein without departing from the spirit of the invention. All such modifications and changes are intended to be covered by the appended claims.

What is claimed is:

1. A method of making a nozzle having multiple tubular ports for dispensing liquids, comprising the steps of:
a) providing a mold assembly, said assembly including a die plate having a plurality of post elements projecting therefrom and a removable connector device attached to the die plate, wherein said connector device surrounds the post elements;
b) inserting a plurality of plastic tubes onto the post elements;
c) introducing a molten polymer composition into the connector device of the mold assembly so that the composition surrounds and bonds to the tubes; and
d) removing the connector device from the mold assembly to form a connector nozzle having multiple tubular ports extending therefrom.

2. The method of claim 1, wherein the connector device has a threaded end for fastening the device to the die plate.

3. The method of claim 2, wherein the connector device is screwed into a threaded, recessed area of the die plate.

4. The method of claim 1, wherein the connector device has a cylindrical structure.

5. The method of claim 1, wherein the post elements and plastic tubes have round cross-sections.

6. The method of claim 5, wherein the post elements and plastic tubes have substantially the same diameters.

7. The method of claim 1, wherein the polymer composition comprises a polymer selected from the group consisting of polyvinyl chloride, polyamides, fluorocarbons, polyethylene, polyurethane, polystyrene, cellulosics, acrylics, epoxies, elastomers, polyesters, polyimides, and acrylonitriles.

8. The method of claim 7, wherein the polymer composition comprises polyurethane.

9. The method of claim 1, wherein the plastic tubes comprise nylon.

10. The method of claim 1, wherein the polymer composition and the plastic tubes have the same polymer composition.

11. The method of claim 1, wherein the polymer composition comprises polyurethane and the plastic tubes comprise nylon.

12. A method of making a nozzle having multiple tubular ports for dispensing liquids, comprising the steps of:
a) providing a die plate having a plurality of post elements projecting therefrom;
b) inserting a plurality of plastic tubes onto the post elements;
c) attaching a removable connector device to the die plate, said connector device surrounding the post elements;
d) introducing a molten polymer composition into the attached connector device so that the composition surrounds and bonds to the plastic tubes; and
e) removing the connector device from the die plate to form a connector nozzle having multiple tubular ports extending therefrom.

13. A connector nozzle having multiple tubular ports extending therefrom made in accordance with the method of claim 1.

14. The connector nozzle of claim 13, wherein the nozzle and projecting plastic tubes are cylindrical in configuration.

15. The connector nozzle of claim 13, wherein the polymer composition that surrounds and bonds to the plastic tubes comprises polyurethane.

16. The connector nozzle of claim 13, wherein the plastic tubes comprise nylon.

17. The method of claim 13, wherein the polymer composition and the plastic tubes have the same polymer composition.

18. The method of claim 13, wherein the polymer composition comprises polyurethane and the plastic tubes comprise nylon.
